(19) United States
(12) Patent Application Publication
(10) Pub. No.: US 2009/0144124 A1
(43) Pub. Date: Jun. 4, 2009

(54) PROVIDING A USER DRIVEN, EVENT TRIGGERED ADVERTISEMENT

(75) Inventors: ARUNGUNRAM C. SURENDRAN, SAMMAMISH, WA (US); LEE-MING ZEN, SEATTLE, WA (US); HRISHIKESH M. BAL, BELLEVUE, WA (US); TAREK NAJM, KIRKLAND, WA (US); KEVIN RIEDY, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/948,739

(22) Filed: Nov. 30, 2007

(51) Int. Cl. G06Q 30/00

(52) U.S. Cl. 705/10; 705/14

(57) ABSTRACT

Systems and methods are provided for adding an advertisement to a web page by associating advertisements with one or more visual objects e.g., text and/or pictures. Embodiments of the present invention include a method for selecting visual objects and associating the visual object with an advertisement after the web page has been displayed to the user. The visual object may be selected in part based on the user's interactions with the web page. An additional embodiment of the present invention displays the associated advertisement after a user clicks on or hovers over the selected visual object.

### BACKGROUND

Internet advertisements are often presented based on the content displayed on a web page. The goal is to match the subject matter of the advertisement with the subject matter of the web page's content. The subject matter of the advertisement is often determined based upon key words that are submitted with the advertisement and/or extracted from the textual content of the advertisement. The subject matter of a web page's content may be automatically determined by a computer program that evaluates words and/or phrases within the textual content of the web page.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention generally relate to displaying an advertisement on a web page after a user interacts with a visual object (e.g., digital photographs and/or text). Examples of user interaction that may cause the advertisement to be displayed include hovering over the visual object or clicking on the visual object. In one embodiment, one or more visual objects on a web page are selected to be associated with advertisements. The visual objects may be selected based on several factors including an advertiser's request to be associated with a specific visual object and a user interaction. The selection process may be a dynamic process that allows selected visual objects to be deselected and previously nonselected visual objects to be selected. With the dynamic selection process, the selection status of a visual object may be changed after the web page is originally rendered. Once a visual object is selected, the appearance of the object is changed in a manner that differentiates it from other nonselected visual objects on the web page. In one embodiment, a secondary indication is provided that communicates the content of the advertisement that will be presented upon user interaction with the selected visual object. In a further embodiment, the selected visual object may be associated with a secondary content other than an advertisement such as an online reference, or online search results.

### BRIEF DESCRIPTION OF THE DRAWINGS

The present invention is described in detail below with reference to the attached drawing figures, wherein:

FIG. 1 is a block diagram of an exemplary computing environment that is suitable for use in implementing embodiments of the present invention;

FIG. 2 is a block diagram of a networked operating environment suitable for use in implementing the present invention;

FIG. 3 is a block diagram of an exemplary computing system architecture suitable for use in implementing embodiments of the present invention;

FIG. 4 is a flow diagram illustrating an exemplary method for associating a visual object on a web page with an advertisement, in accordance with an embodiment of the present invention;

FIG. 5 is flow diagram illustrating an exemplary method in a computer system for displaying on a display device a secondary content associated with an interactive visual object within a web page, in accordance with an embodiment of the present invention;

FIG. 6 is a diagram of a graphical user interface that is configured to display a web page containing pictures and text according to an embodiment of the present invention;

FIG. 7 is a diagram of a graphical user interface that is configured to display a web page containing pictures and text in association with a first visual indication, in accordance with an embodiment of the present invention;

FIG. 8 is a diagram of a graphical user interface that is configured to display a web page containing pictures and text in association with a first visual indication and second visual indication, in accordance with an embodiment of the present invention; and

FIG. 9 is a diagram of a graphical user interface that is configured to display a an advertisement in response to a user interaction with the first visual indication and/or second visual indication, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Accordingly, in one embodiment, a computer system is provided that includes a computer storage medium having a plurality of computer software components embodied thereon to add advertising content to a web page. The system includes a call receiving component for receiving a call from a web browser, a user-interaction component for receiving user-interaction data from the web browser that describes a user interaction with the web page, and a selection component for selecting a first visual object on the web page to associate with an advertisement. The system also includes a modification component for sending a modification instruction to the web browser to modify the first visual object so that the first visual object presents the advertisement to a user in response to a first user interaction with the first visual object and to modify the appearance of the first visual object so that the first visual object is differentiated from surrounding nonselected visual objects.

In another embodiment, a method is provided for associating advertisements with visual objects on a web page. The method includes selecting one or more visual objects within the web page to associate with an advertisement based at least on user interaction data received after the web page is requested by a user. The method also includes causing the one or more visual objects to be transformed into one or more interactive visual objects that present an associated advertisement to the user when the user interacts with the one or more interactive visual objects and causing the one or more interactive visual objects to be displayed with a first visual indication that the one or more visual objects are interactive. the method further includes causing a second visual indication to be displayed adjacent to the one or more interactive visual objects that communicates a characteristic of the associated advertisement that is presented upon a user interaction with the one or more interactive visual objects.

In yet another embodiment, a method in a computer system is provided for displaying on a display device a secondary content associated with an interactive visual object within a web page, wherein the secondary content is presented in response to a user interaction with the interactive visual object that is received through a user interface selection device. The method includes displaying on the display device a first visual indication for an interactive visual object, wherein the first visual indication distinguishes the interactive visual object from a noninteractive visual object. The method further includes displaying on the display device a second visual indication that communicates a characteristic of the secondary content, wherein the second visual indication is proximate to the first visual indication, and displaying on the display device the secondary content upon receiving interaction data from the user interface selection device.

Having briefly described an overview of embodiments of the present invention, an exemplary operating environment suitable for use in implementing embodiments of the present invention is described below.

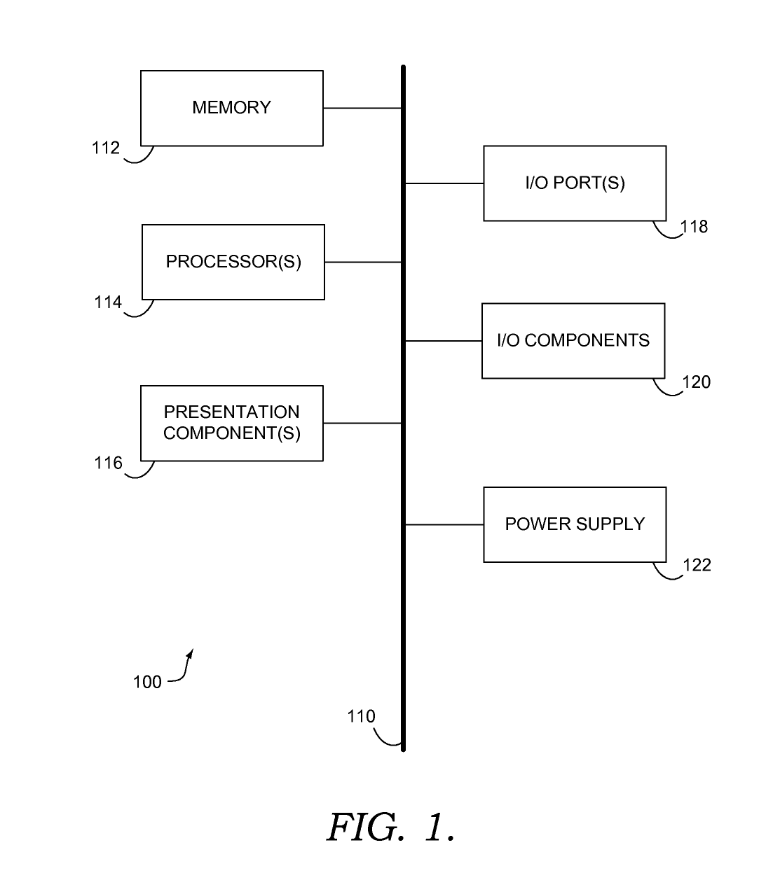

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other hand-held device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices; or any other medium that can be used to encode desired information and be accessed by computing device 100.

Memory 112 includes computer storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

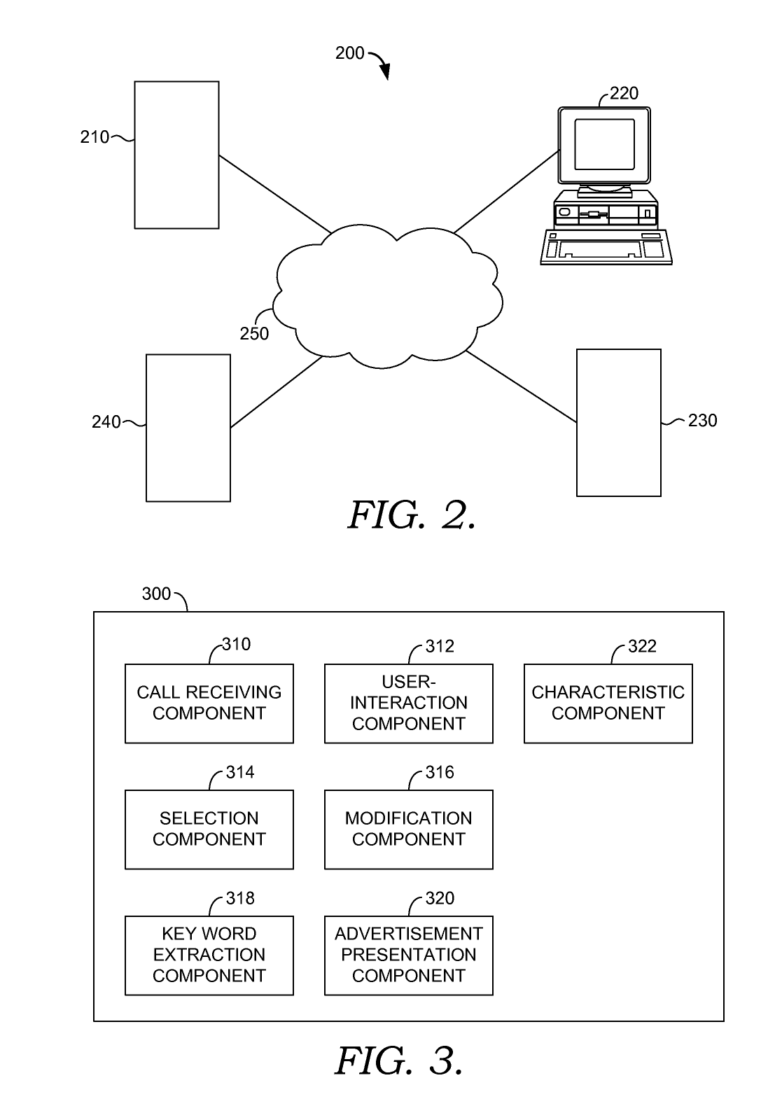

Turning now to FIG. 2, a block diagram depicting a networking architecture 200 is shown for use in implementing an embodiment of the present invention in a distributed computing environment. The networking architecture 200 comprises client computing device 220 and servers 210, 230, and 240 all of which communicate with each other via network 250. Networking architecture 200 is merely an example of one suitable networking environment and is not intended to suggest any limitation as to the scope of use or functionality of the present invention. Neither should networking architecture 200 be interpreted as having any dependency or requirement related to any single component or combination of components illustrated therein.

The client computing device 220 may be a type of computing device, such as device 100 described above with reference to FIG. 1. By way of example only and not limitation, the client computing device 220 may be a personal computer, desktop computer, laptop computer, handheld device, cellular phone, consumer electronic, digital phone, smartphone, PDA, or the like. It should be noted that embodiments are not limited to implementation on such computing devices.

Network 250 may include a computer network or combination of computer networks. Examples of networks configurable to operate as network 250 include, without limitation, a wireless network, landline, cable line, digital subscriber line (DSL), fiber-optic line, local area network (LAN), wide area network (WAN), metropolitan area network (MAN), or the like. Network 250 is not limited, however, to connections coupling separate computer units. Rather, network 250 may also comprise subsystems that transfer data between servers or computing devices. For example, network 250 may also include a point-to-point connection, the Internet, an Ethernet, an electrical bus, a neural network, or other internal system. Furthermore, network 250 may include a WiMAX-enabled infrastructure (i.e., components that conform to IEEE 802.16 standards).

The servers 210, 230, and 240 may be a type of application server, database server, or file server configurable to perform the methods described herein. In addition, each of the servers 210, 230, and 240 may be a dedicated or shared server. Components of the servers 210, 230, and 240 may include, without limitation, a processing unit, internal system memory, and a suitable system bus for coupling various system components, including one or more databases for storing information (e.g., files and metadata associated therewith). Each server may also include, or be given access to, a variety of computer-readable media.

It will be understood by those of ordinary skill in the art that networking architecture 200 is merely exemplary. While the servers 210, 230, and 240 are illustrated as single boxes, one skilled in the art will appreciate that they are scalable. For example, the server 240 may in actuality include multiple boxes in communication. The single unit depictions are meant for clarity, not to limit the scope of embodiments in any form.

As shown in FIG. 3, the computing system environment 300 includes a call receiving component 310, a user-interaction component 312, a selection component 314, a modification component 316, a key word extraction component 318, an advertisement presentation component 320, and a characteristic component 322. Embodiments may be implemented without one or more the components 310, 312, 314, 316, 318, 320, and 322 being utilized in the embodiment. For example, at least one embodiment does not contain components 318, 320, and 322. In some embodiments, one or more of the illustrated components may be implemented as stand-alone applications. In other embodiments, one or more of the illustrated components may be integrated directly into the operating system of one or more computing devices within computing system environment 300. All components within computing system environment 300 may be communicatively coupled to any of the other components within computing system environment 300. It will be understood by those of ordinary skill in the art that the components 310, 312, 314, 316, 318, 320, and 322 illustrated in FIG. 3 are exemplary in nature and in number and should not be construed as limiting. Any number of components may be employed to achieve the desired functionality within the scope of embodiments of the present invention. In addition, each component may reside on more than one computing device within computing system environment 300.

The call receiving component 310 is configured for receiving a call sent by a web browser. Upon receiving the call, the call receiving component 310 initiates the systems and methods which will be described hereafter. The call may include information about the web browser, a URL, one or more cookies, and additional information as may be necessary or desired. In one embodiment, the call is initiated by a JavaScript running on the web browser that is executed as the web page loads into the web browser. In this embodiment, all that a web page owner must do to use the systems and methods described hereafter is to add the JavaScript to the web page. The rest of the system and process may reside on one or more computers that are communicatively coupled to the web servers that host the web site to which the JavaScript is added. The call receiving component 310 may be communicatively coupled to other components within computing system 300.

User-interaction component 312 is configured for receiving and tracking user interactions with a web page and/or objects on the web page. Examples of user interactions that may be tracked include, but are not limited to, a mouse click, hovering with the mouse pointer over an object or over a section of a web page, scrolling up or down the web page, highlighting, and all variety of keyboard entries. The user-interaction component 312 may be communicatively coupled to other components within computing system 300.

The selection component 314 is configured to select visual objects within a web page. A visual object is any item that is displayed on a web page. Examples of visual objects include, but are not limited to, words, pictures, sentences, phrases, graphics, and icons. The selection component 314 may consider a variety of criteria when selecting a visual object. By way of example, and not limitation, factors that may be considered include whether the visual object is a key word, the overall subject matter of the web page, the prominence of the visual object on the web page, and/or user interactions with the web page and/or visual object. In one embodiment, the selection component 314 receives key words that are extracted from the text on a web page by the key word extraction component 318, which is described hereafter. In another embodiment, the selection component 314 considers user interaction with the web page when selecting one or more visual objects. For example, when the user interaction shows that the user has scrolled down a page to a certain point, then visual objects in that area of the web page may be selected. One aspect of this embodiment is that the selection status of visual objects may change as the user is viewing and interacting with the web page. Visual objects that were initially selected as the web page was being rendered may be deselected based on user interaction that reveals a lack of interest in the initially selected visual object. Conversely, previously unselected visual objects may then be selected based on user interactions that reveal an interest in those visual objects. Selecting visual objects in which the user is interested increases the likelihood that the user will be interested in viewing a secondary content (e.g., advertisement, video, link to online store, link to an online reference, a link to search results for the associated visual objects, etc.) that is associated with the selected visual objects.

Key word extraction component 318 is configured to extract key words from web page text. Key words may be words with which advertisers would like to associate one or more advertisements. For example, in a text sentence the word truck could be extracted as a key word to associate with advertisements for one or more truck manufacturing companies. In another example, the name of a book, could be associated with an on-line book retailer. In yet another example, the name of an actress could be associated with a recent movie in which she stars. The key word extraction component 318 may take the context of the entire web page into consideration when extracting key words. Key words may exemplify the subject matter of the text.

The modification component 316 is configured to cause the web browser to modify the presentation of a visual object selected by selection component 314. In one embodiment, this is performed by sending an instruction that causes the document object model (“DOM”) to be modified in such a way that the presentation of the selected visual object is changed. The modification component may send these instructions as a web page is initially rendered, during rendering, and/or any time after the web page has been displayed. The presentation of the selected visual object may be changed in any number of ways that indicates to the user that the visual object is interactive. For example, if the selected visual object is text, the selected text could be modified to be bold, underlined, double underlined, flash, and/or presented in a different color than the surrounding text. In one embodiment, the selected text is double underlined and presented in a different color than the surrounding text. In another embodiment, the selected text is highlighted. If the visual object is a picture, the picture could be highlighted or otherwise surrounded with markings that indicate the picture is interactive. In one embodiment, the modification to the visual object's appearance could provide an indication that describes the nature of the secondary content that is presented upon a user interaction with the visual object. These examples are not meant to be limiting, and any method or combination of methods of differentiating a visual object from surrounding visual objects may be employed.

In addition to modifying the appearance of a selected visual object, the modification component 316 also changes the selected visual object into an interactive visual object. An interactive visual object is an object that will present a secondary content (e.g., advertisement, video, link to online store, link to an online reference, a link to search results for the associated visual object, etc.) when the user interacts with the interactive visual object. In one embodiment, an interactive visual object presents an advertisement in a separate window when the user hovers on the selected visual object. Hovering is holding the pointer over the visual object without clicking on the visual object. In another embodiment, the interactive visual object displays an advertisement when the user clicks on the visual object. In one embodiment, the advertisement may disappear when the user clicks on a different section of the web page, on a different visual object, or just moves the mouse to a different area of the web page. The interactive visual object may initially be associated with a specific advertisement, or a general subject-matter category of advertisements. If the interactive visual object is associated with a general subject-matter category of advertisements, the actual advertisement may be selected at the time the user initially interacts with the interactive visual object.

Characteristic component 322 is configured for providing a secondary indication adjacent to the interactive visual object that describes characteristics of the secondary content (e.g., advertisement, link to online store, etc.) that will be presented upon user interaction with the interactive visual object. The secondary indication may describe characteristics of the secondary content in terms of subject matter or classification. For example, if the selected visual object is a truck and the associated advertisement is a video of a Ford truck, then the secondary indication could be the Ford logo with a film reel icon. The Ford logo would describe the subject matter of the associated advertisement, while the film reel would describe the classification of the associated advertisement. The characteristic component 322 may provide a secondary indication of just the subject matter, just the classification, or both the classification and the subject matter. In one embodiment, the secondary indication is small enough not to disrupt the surrounding web page. Specifically, the secondary indication may be small enough not to disrupt or cover surrounding text. Similarly, if the selected object is a picture, the secondary indication may be small enough not to obstruct surrounding text, pictures, or icons. In one embodiment, the secondary indication is also interactive so that user interaction with either the selected visual object or the secondary indication will result in presentation of the associated secondary content. Some embodiments may not include the characteristic component 322, and may not provide a secondary indication.

The advertisement presentation component 320, is configured to select advertisements to associate with the selected visual objects and to send those advertisements to the web browser for presentation upon user interaction with the selected visual object or secondary indication. In one embodiment, the advertisement presentation component 320 is communicatively coupled to an advertising database (not shown). The advertising presentation component 320 may be configured to track the presentation of advertisements, user interactions with an advertisement (e.g., clicks on the advertisement), and purchases made by users who clicked on an advertisement. In one embodiment, the advertisement presentation component 320 uses key words associated with an advertisement to match the advertisement with key words identified in the text. For this reason, the advertisement presentation component 320 and the key word extraction component 318 may work together closely. The advertisement presentation component 320 may be configured to receive advertisements from advertisers, including over the Internet. Additionally, the advertisement presentation component 320 may also manage the selection of secondary content other than advertisements. By way of example, and not limitation, videos, links to online stores, links to online references, and links to search results may be selected for association by the advertisement presentation component 320.

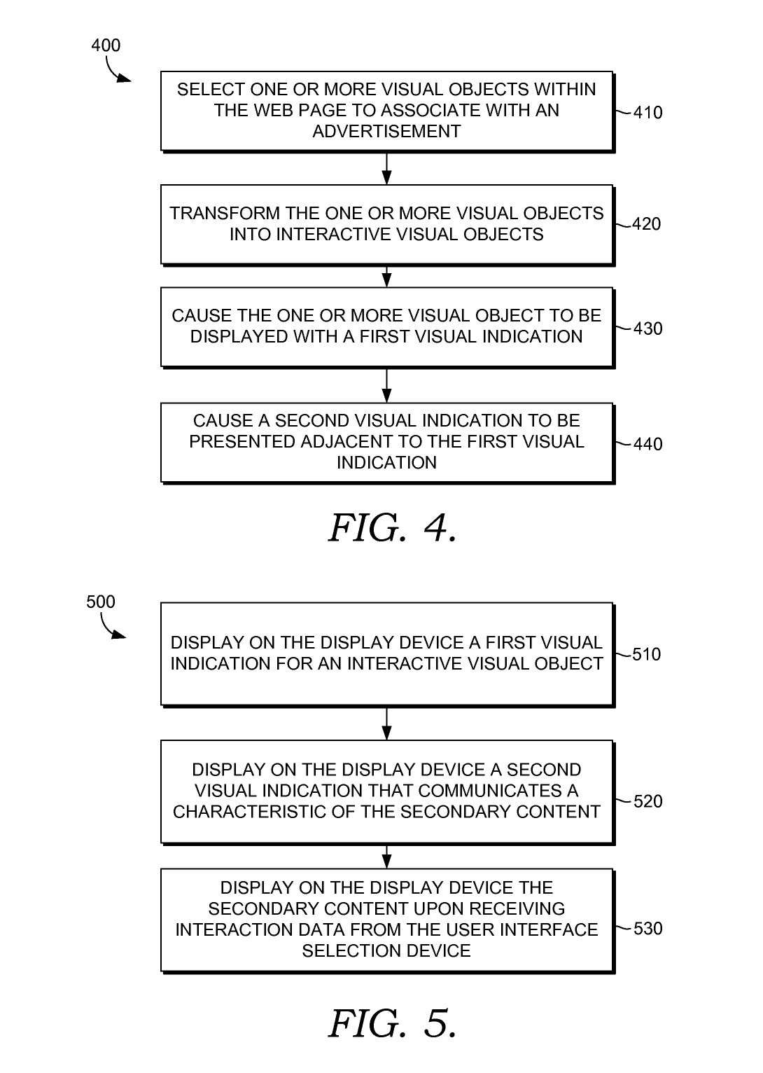

Referring next to FIG. 4, a flow diagram showing an exemplary method for linking an advertisement to a visual object on a web page is illustrated and designated generally as reference numeral 400. At step 410, one or more visual objects on a web page are selected to be associated with an advertisement. In one embodiment, visual objects are selected before, during, and after the web page is initially displayed. Additional visual objects may be selected after the web page has been displayed. In addition, initially selected visual objects may be deselected. As stated previously, a visual object is any object that may be displayed on a web page (e.g., text or a picture).

The visual object may be selected using a variety of criteria. The goal is to select visual objects about which the user would like more information. In one embodiment, the visual object is identified based on user interaction that demonstrates an interest in the visual object or section of the web page on which the visual object is located. By way of example, and not limitation, data such as user demographic information, user geographic information, user browsing history, user search engine history, a user's social circle, an user's social network, a recommendation from a friend within the user's social circle, and advertising key word information may be used to help select a visual object.

In addition, advertising monetization factors may also be considered when selecting the visual object to associate with an advertisement. For example, if there is no advertisement to associate with a visual object in which the user shows an interest that visual object should not be selected. Conversely, a visual object that may be associated with an advertisement is a better candidate for selection. Examples of advertising monetization factors include the probability that a particular advertisement will be selected by a viewer, the probability that a product will be purchased through an advertisement presented to the viewer, the amount of money an advertiser is willing to pay to have an advertisement presented, and the number of advertisers submitting advertisements within a subject-matter category. Further, in one embodiment an auction is implemented that allows advertisers to bid on how much they are willing to pay for displaying an advertisement on a roll over, click, or further interactions with the selected object or presented advertisement. All information regarding the presentation of advertisements, and user interactions with the advertisements may be tracked with the goal of compensating one or more parties.

At step 420, the one or more selected visual objects are caused to be transformed into interactive visual objects that present an advertisement to a user when the user interacts with the interactive visual object. When a visual object is interactive an advertisement is displayed when a user interacts with the visual object. Examples of interaction that may initiate presentation of the advertisement include clicking or hovering on the visual object. Hovering is placing the pointer over the visual object without clicking on the visual object. A visual object may be transformed into an interactive visual object by sending a message to the web browser that is displaying the web page. Visual objects may be transformed into interactive objects after the web page is displayed or anytime before the web page is displayed. Additionally, the interactive status of a visual object may be changed after the page is initially displayed. Noninteractive visual objects may be transformed into interactive visual objects and interactive visual objects may be transformed back into noninteractive visual objects after the web page has been initially displayed.

In one embodiment, a first visual object is transformed into an interactive visual object based on a first user interaction with the visual object or web page near the visual object. Subsequently, the first visual object is transformed back into a noninteractive visual object based on a second user interaction. In one embodiment, a second visual object is then transformed into an interactive visual object based on a third user interaction. In this embodiment, the second and third user interactions may be the same user interaction.

At step 430, the one or more visual objects selected for association with an advertisement are caused to be displayed with a first indication. The first indication is meant to differentiate the interactive visual objects from noninteractive visual objects on the web page. The first visual indication may be highlighting the visual object. If the interactive visual object is text, the first visual indication may include changing the color of the interactive text to contrast it with noninteractive text, underlining the interactive text, double underlining the interactive text, and bolding or italicizing the interactive text. A message may be sent to the web browser that causes the first indication to be displayed to the user. As the interactive status of a visual object changes, a first indication may be added or removed from the visual object by sending an appropriate instruction to the web browser.

At step 440, a second visual indication is caused to be presented adjacent to the first visual indication. The second visual indication communicates the characteristics of the advertisement that is associated with the one or more interactive visual objects. As described previously, the characteristics of the advertisement may be described in terms of both subject matter and classification. An example of a subject matter is the product featured in an advertisement. Examples of a classification include, but are not limited to, a video, an informational web page, an online store, or other indication of the form of the advertisement. In one embodiment, a second visual indication is also interactive. A legend may be displayed to help the user interpret the meaning of the secondary indication.

Referring next to FIG. 5, a flow diagram showing an exemplary method for displaying on a display device a secondary content associated with a visual object within a web page is illustrated and designated generally as reference numeral 500. At step 510, a first visual indication for an interactive visual object is displayed on the display device. As described previously, the first visual indication changes the appearance of the visual object so that it is differentiated from visual objects that are not interactive. The methods of providing a first visual indication include, but are not limited to, causing the visual object to flash, highlighting the visual object, underlining the visual object, double underlining the visual object, changing the color of the visual object, bolding the visual object, or italicizing the visual object. The first visual indication may be provided after a web page is displayed, or as the web page is initially displayed. The first visual indication may be removed from a visual object or added to a visual object after the web page is displayed.

At step 520, a second visual indication that communicates the characteristics of the secondary content is displayed on the display device. As described previously, the secondary visual indication communicates the characteristics of the secondary content that is displayed upon receiving a user interaction. Secondary content is any online content that is not initially displayed on the web page. The characteristics of the secondary content may be described in terms of subject matter and classification. The secondary visual indication may be displayed in proximity to the first visual indication. In addition, a legend may be displayed on a web page that describes the meaning of one or more secondary visual indications.

At step 530, upon receiving interaction data from the user interface selection device, the secondary content is displayed on the display device. By way of example, and not limitation, the interface selection device may be a mouse, trackball, writing tablet, touch screen, or keyboard. The display device may display an indication (e.g., cursor, pointer, mouse, arrow, hand, etc.) showing what part of the display the interface selection device is interacting with. In one embodiment, the secondary content is displayed in a second window (e.g., a pop-up window) that covers part of the web page, but not the interactive visual object. The window may be translucent so that the web page is visible through the content in the second window. The presentation of the second window may be discontinued when the user moves the pointer off the interactive visual object, or selects another section of the web page. Clicking on the second window or moving the pointer onto the window may cause the second window to be enlarged. A button may be provided for the user to click on and close the second window. In another embodiment, the secondary content is displayed elsewhere on the web page. For example, the secondary content to be displayed in a banner ad that is update based on the selection or in a column adjacent to text on the web page.

In one embodiment, a JavaScript is initially included in a web page hosted on a first server connected to the Internet. Upon loading the web page, the JavaScript is executed by a web browser and calls a designated application that runs on a second server that is communicatively coupled to the Internet. The first and second server may be the same server or two separate severs. The designated application causes functions to be attached to visual objects within the web page and the appearance of selected visual objects to be changed, as described previously. The functions attached to the visual objects may make the visual objects interactive. For example, a function onmouseove could be attached to a visual object so that a function is performed when the mouse is run over the visual object. The function would be executed by the web browser that is displaying the web page. This function could include calling back to the designated application to receive secondary content. However, the function could also have the web browser call to a third party server to request secondary content. The secondary content may then be provided by the third party, without the assistance of designated application that originally caused the function to be attached to the visual object. In one embodiment, the secondary content is associated with an interactive visual object upon the transformation of the visual object into an interactive visual object. In another embodiment, the secondary content is not associated with an interactive visual object until a user interaction with the interactive visual object occurs. Waiting to associate a secondary content with an interactive visual object allows additional user behaviors to be observed and incorporated into choosing the most relevant secondary content.

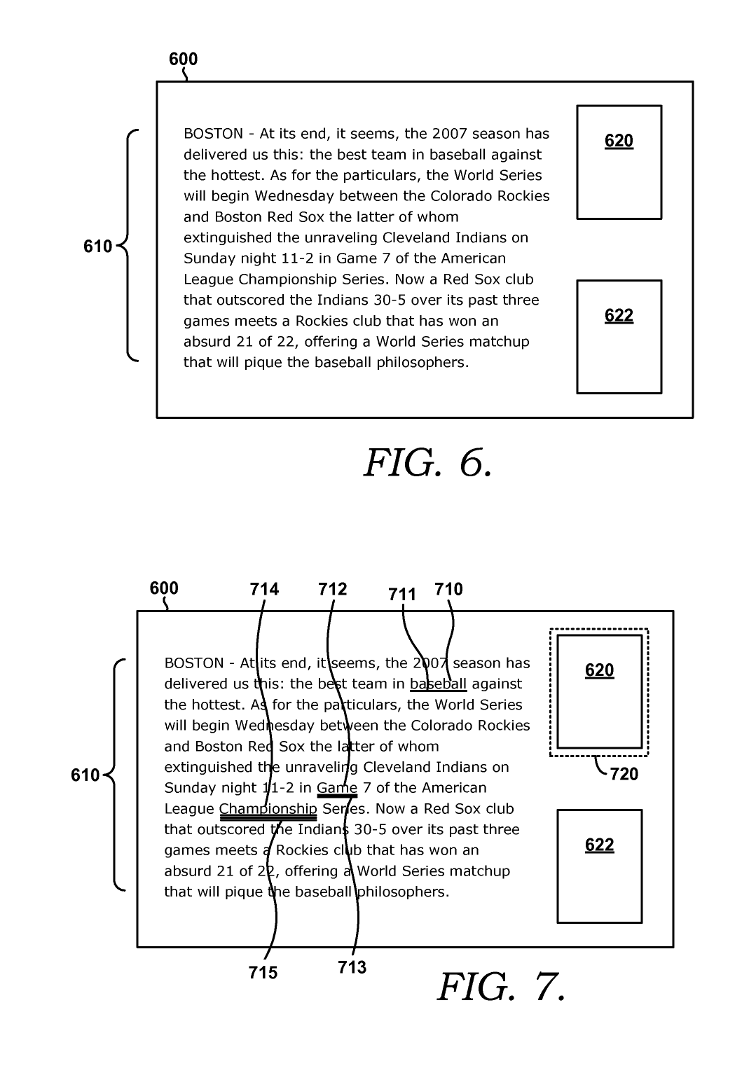

Referring next to FIGS. 6-9, line diagrams illustrating a user interface for practicing an embodiment of the present invention are shown and designated generally as user interface 600. User interface 600 shows a web page that includes text 610 and digital pictures 620 and 622. For the sake of simplicity web browser details which may be present in the user interface are not shown. The text 610, and digital pictures 620 and 622 are examples of visual objects.

Turning to FIG. 7, three words 710, 712, and 714 within the text 610 have been transformed into interactive visual objects. Different first visual indications 711, 713, and 715 are used for each word 710, 712, and 714 in this example. However, the same first visual indication could just as easily be used throughout a web page. The first visual indications shown on user interface 600, include a single underline 711, a double underline 713, and a triple underline 715. Digital photograph 620 has been also been transformed into an interactive visual object and displayed with first visual indication 720, which is a highlight (shown as hash marks).

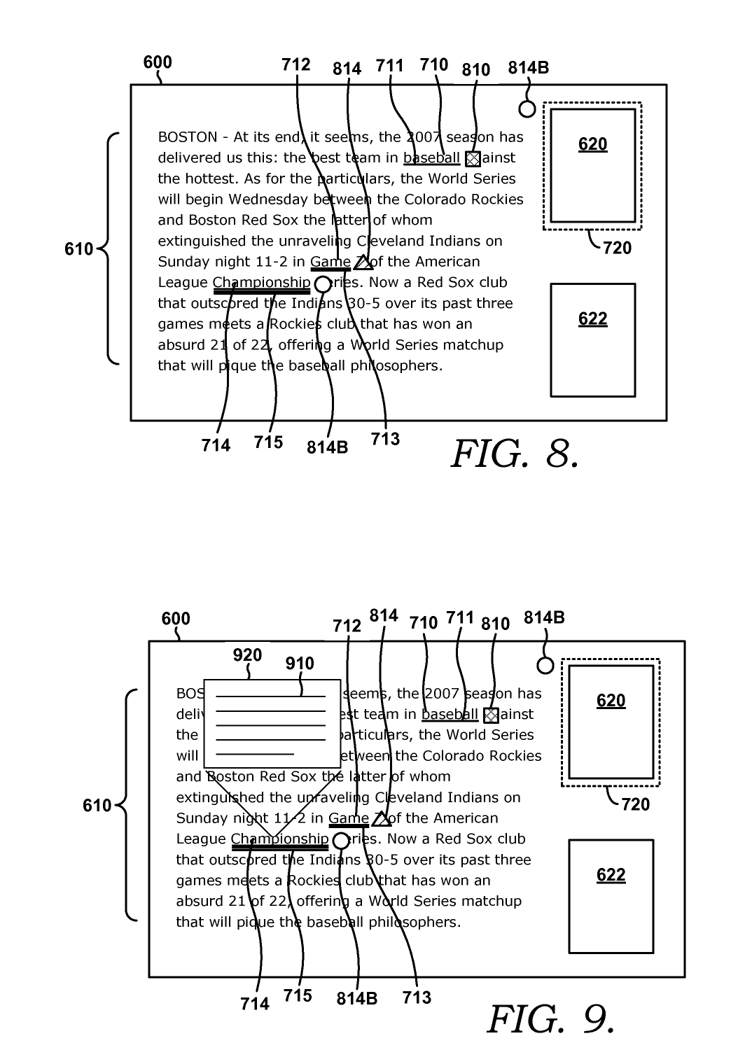

Turning next to FIG. 8, user interface 600 is shown with secondary indications 810, 812, 814A, and 814B presented adjacent to the first indications 711, 713, and 715. The secondary indications may be identical to other secondary indications on the web page, as with secondary indications 814A and 814B. Unique secondary indications may also be used throughout the page. In addition, the same key word, such as baseball 710 may be selected many times on the web page and associated with the same, or different, secondary content. Though shown with only one secondary visual indication for each first visual indication, more than one secondary visual indication may be provided for each first visual indication.

Turning now to FIG. 9, secondary content 910 is shown presented in a new window 620 on user interface 600. In one embodiment, the secondary content is presented after the user hovers over text 714.

The present invention has been described in relation to particular embodiments, which are intended in all respects to be illustrative rather than restrictive. Alternative embodiments will become apparent to those of ordinary skill-in-the-art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. One or more computer storage media having a plurality of computer software components embodied thereon to add advertising content to a web page, the system comprising:
a call receiving component for receiving a call from a web browser;
a user-interaction component for receiving user-interaction data from the web browser that describes a user interaction with the web page;
a selection component for selecting a first visual object on the web page to associate with an advertisement; and
a modification component for sending a modification instruction to the web browser to modify the first visual object so that the first visual object presents the advertisement to a user in response to a first user interaction with the first visual object and to modify the appearance of the first visual object so that the first visual object is differentiated from surrounding nonselected visual objects.

2. The media of claim 1, further comprising a key word extraction component for selecting one or more key words within text on the web page and communicating the one or more key words to the selection component.

3. The media of claim 1, wherein the selection component is further configured to select an unselected visual object after the web page has been displayed, wherein the selection of the unselected visual object is based at least on a second user interaction that occurs after the web page has been displayed to the user.

4. The media of claim 1, wherein the selection component is further configured to deselect a selected visual object after the web page has been displayed, wherein the selected visual object is deselected based at least on a third user interaction that occurs after the web page has been displayed to the user.

5. The media of claim 1, further comprising an advertisement presentation component for:
choosing the advertisement to associate with the first visual object based at least on the nature of the first visual object; and
sending the advertisement to the web browser.

6. The system of media 1, wherein the first visual object is selected based on one or more user interactions including one or more of a click on the first visual object and a hover over the first visual object.

7. The system of media 1, further comprising:
a characteristic component for sending a content-characteristic instruction to the web browser to provide a second visual object that communicates a characteristic of the advertisement that is presented in response to the interaction with the first visual object.

8. A method for associating advertisements with visual objects on a web page, the method comprising:
selecting one or more visual objects within the web page to associate with an advertisement, wherein the one or more visual objects are selected based at least on user interaction data received after the web page is requested by a user;
causing the one or more visual objects to be transformed into one or more interactive visual objects that present an associated advertisement to the user when the user interacts with the one or more interactive visual objects;
causing the one or more interactive visual objects to be displayed with a first visual indication that the one or more visual objects are interactive; and
causing a second visual indication to be displayed adjacent to the one or more interactive visual objects that communicates a characteristic of the associated advertisement that is presented upon a user interaction with the one or more interactive visual objects.

9. The method of claim 8, further comprising transforming an interactive visual object back into a noninteractive visual object after the web page has been displayed, wherein the transforming of the interactive visual object is based at least on user interaction data that is received after the web page has been displayed to the user.

10. The method of claim 8, further comprising transforming one or more noninteractive visual objects into one or more interactive visual objects after the web page has been displayed, wherein the transforming of the one or more noninteractive visual objects is based at least on user interaction data that is received after the web page has been displayed to the user.

11. The method of claim 10, wherein the user interaction includes one or more of:
a click;
a hover over a visual object;
a scroll up the web page;
a scroll down the web page;
a dwell time on the web page;
a keystroke on a keyboard; and
a highlight of a visual object.

12. The method of claim 8, further comprising associating each of the one or more interactive visual objects with a related advertisement so that the related advertisement is displayed when the user interacts with the one or more interactive visual objects.

13. The method of claim 8, wherein an interactive visual object is a word that is identified by a key word extraction program.

14. The method of claim 8, wherein the first visual indication is one or more of:
an underline;
a double underline;
a bold;
a highlight;
a flash; and
a color change.

15. A method in a computer system for displaying on a display device a secondary content associated with an interactive visual object within a web page, wherein the secondary content is presented in response to a user interaction with the interactive visual object that is received through a user interface selection device, the method comprising:
displaying on the display device a first visual indication for an interactive visual object, wherein the first visual indication distinguishes the interactive visual object from a noninteractive visual object;
displaying on the display device a second visual indication that communicates a characteristic of the secondary content, wherein the second visual indication is proximate to the first visual indication; and
displaying on the display device the secondary content upon receiving interaction data from the user interface selection device.

16. The method of claim 15, wherein the secondary content is displayed upon receiving the interaction data from the user interface selection device that indicates a user is interacting with the first visual indication.

17. The method of claim 15, wherein the secondary content is displayed upon receiving the interaction data from the user interface selection device that indicates a user is interacting with the second visual indication.

18. The method of claim 15, wherein the secondary content includes one or more of the following:
an advertisement;
a video;
a digital picture;
an online reference;
an online store; and
a search result for the interactive visual object.

19. The method of claim 15, wherein the interaction data from the user interface selection device includes one or more of the following:
a click;
a hover over a visual object;
a scroll up the web page;
a scroll down the web page;
a dwell time on the web page;
a keystroke on a keyboard; and
a highlight of a visual object.

20. The method of claim 15, further comprising displaying on the display device a legend that explains the meaning of one or more second visual indications.
